(19) United States
(12) Patent Application Publication
(10) Pub. No.: US 2007/0208574 A1
(43) Pub. Date: Sep. 6, 2007

(54) System and method for managing master data information in an enterprise system

(76) Inventors: Zhiyu Zheng, San Mateo, CA (US); Cynthia Chan, San Jose, CA (US); Stefano Lindt, Belmont, CA (US); Hwee Har Yeap, San Mateo, CA (US); Ming-Tao Liou, Fremont, CA (US)

Correspondence Address: CSA LLP, 4807 SPICEWOOD SPRINGS RD., BLDG. 4, SUITE 201, AUSTIN, TX, 78759, US

(21) Appl. No.: 10/183,022

(22) Filed: Jun. 27, 2002

(51) Int. Cl. G06Q 10/00; G06Q 30/00

(52) U.S. Cl. 705/1

(57) ABSTRACT

A system and method for the management of information in an enterprise system are disclosed. In one embodiment, the enterprise system includes a primary system and a legacy system. The primary system includes an application or interface that can be used to communicate with and receive communications from a legacy system. In another embodiment, a legacy system can include an application or interface that can be used to communicate with and receive communications from the primary system. The primary system includes a database with information for the enterprise system. In one embodiment, the primary system provides updates to the legacy system of any changes in the information in the database. In another embodiment, a legacy system can select updates to particular enterprise information that it wants to receive from the primary system.

### BACKGROUND OF THE INVENTION

1. Field of the Invention

This invention relates generally to the field of data processing, and more particularly, to techniques for managing customer information in an enterprise system.

2. Discussion of Related Art

As technology continues to advance and the business environments have become increasingly complex and diverse, more and more companies have relied on various customer relationship management (CRM) software and eBusiness applications to conduct and manage various aspects of their enterprise business. In general, eBusiness applications are designed to enable a company or enterprise to conduct its business over an interactive network (e.g., Internet, Intranet, Extranet, etc.) with its customers, partners, suppliers, distributors, employees, etc. eBusiness applications may include core business processes and supply chain, back-office operations, and CRM functions.

In many industries, a conventional enterprise may have multiple offices that are geographically separated. Each office may include a system and/or one or more applications that likely utilize information that is common to the enterprise. Thus, the various systems in an enterprise need access to enterprise information for their business processes. Sometimes the customer information residing in an eBusiness application or system can be integrated with information residing within various legacy operational systems in the same enterprise. Interfaces between eBusiness applications and legacy systems that contain vast stores of customer information have been developed.

In some conventional enterprises, an eBusiness application and a legacy system each includes a database that contains business information. The eBusiness application and the legacy system can communicate and share their information through the exchange of messages. One type message is a request by one system for information from another system. Another type message is a response with requested information from one system to another system.

Some conventional enterprises include a primary system is usually the master of the information for the enterprise. For example, the primary system may manage and maintain the enterprise information. When a legacy system in the enterprise wants to access some of the enterprise information, the legacy system can send a message.

In some systems, the primary and legacy systems may store information differently and use different types of information. For example, a legacy system may intake twenty different fields of information from a customer. Alternatively, the primary system may only store ten of those fields in the enterprise database for each customer.

Messages exchanged between the legacy systems and the primary system within the enterprise typically relate to business transactions that involve the processing of information. For example, a business transaction may involve the addition of a new customer to the database of the primary system. Other business transactions can be the addition or modification of information for a customer that exists in the database already.

The exchanges of information between the primary and legacy systems need to be formatted by the sending system for receipt by the receiving system. For example, prior to sending the information to the primary system, the legacy system needs to format the information and identify the desired business transaction in a format that the primary system can receive and process.

In conventional systems, middleware applications were used to customize the exchange of information between a primary system and other legacy systems. However, in an enterprise with multiple legacy systems, each legacy system required a different middleware application customization to communicate with the primary system. The middleware applications were usually designed for use with a particular legacy system and therefore could not be used with other legacy systems. This method is usually known as the point-to-point communication topology. Accordingly, development of middleware applications became expensive and time-consuming.

As noted above, systems in an enterprise typically share and exchange information. In order to effectively conduct business, systems need to have access to current and accurate information. Therefore, systems need to be informed of any changes in the enterprise information. Typically the addition of new information or the modification of existing information occur during the course of business.

Conventional enterprise systems lack any mechanism that provides automated updates of information to one or more systems within an enterprise. One solution to the distribution of new or modified information is to require that each legacy system in the enterprise periodically check for the primary system database changes. This solution is time intensive and inefficient, particularly in view of the records that a primary system database typically stores as well as the network traffic caused by the polling of data from the primary system.

What is therefore needed is the automation of communications between a primary system and one or more legacy systems. What is also needed is a technique that provides automated updates to enterprise information to one or more systems in an enterprise.

### SUMMARY OF THE INVENTION

The present invention provides a system and method for the management of information in an enterprise system. In one embodiment, the enterprise system includes a primary system and a legacy system. The primary system includes an application or interface that can be used to communicate with and receive communications from a legacy system. In another embodiment, a legacy system can include an application or interface that can be used to communicate with and receive communications from the primary system.

The primary system includes a database with information for the enterprise system. In one embodiment, the primary system provides updates to the legacy system of any changes in the information in the database. In another embodiment, a legacy system can select updates to particular enterprise information that it wants to receive from the primary system.

### BRIEF DESCRIPTION OF THE DRAWINGS

FIG. 1 illustrates an operating environment in which the invention can be practiced.

FIG. 2 illustrates an alternative operating environment in which the invention can be practiced.

FIG. 3 illustrates a system administration view according to an example embodiment of the invention.

FIG. 4 illustrates a contact reference administration view according to an example embodiment of the invention.

FIG. 5 illustrates a company reference administration view according to an example embodiment of the invention.

FIG. 6 illustrates a household reference administration view according to an example embodiment of the invention.

FIG. 7 illustrates a flowchart of an exemplary method of the invention.

FIG. 8 illustrates a publish/subscribe view according to an example embodiment of the invention.

FIG. 9 illustrates a system privileges administration view according to an example embodiment of the invention.

### DETAILED DESCRIPTION OF THE INVENTION

In one embodiment, an enterprise system can include a primary application or system and one or more legacy applications or systems. The term “primary system” is used generically to represent a system or eBusiness application that maintains business information for the enterprise system. For example, a primary system can include a database in which information or data, such as customer-related information or data, of the enterprise system can be stored. The term “legacy system” is used generically to represent any system or application that is separate from and/or external or remote to the primary system in the enterprise system. A legacy system can be any type of system.

In one embodiment, the primary system includes a database that is used as the master of the enterprise information. The primary system can update and maintain the information in the database. In one embodiment, the enterprise can be a bank and the primary data system can be located at the headquarters of the bank. Typically a bank includes multiple remote operations, such automatic teller machines (ATMs) and branch offices. The ATMs and the branch offices can be considered to be different legacy systems that are part of the enterprise system.

The primary system and the legacy system can store and use information in different formats. For example, the primary system and the legacy system can utilize different types or fields of information. In one embodiment, a legacy system may intake twenty different types or fields of information from a customer. On the other hand, the primary system may only use or store ten of those types or fields of information for a customer.

One way in which a legacy system can access information in the primary system database is to send a request to the primary system. One type of request is a request for information or the performance of a business process or transaction on the business information.

In one embodiment of the invention, the primary system includes one or more applications or interfaces that facilitate communications with legacy systems for business transactions. The term “interface” is used to represent an application service interface (ASI) that is an atomic business process or transaction. An ASI provides a standard interface definition to legacy systems communicating with the primary system. The ASIs can be grouped into related sets of ASIs, each of which solves a specific business process. ASIs are discussed in greater detail below.

The interfaces can be universal for all of the systems in an enterprise, and therefore eliminate any need for resolution of information conflicts between the systems. The interfaces also eliminate the occurrence of insufficient data integrity during business transactions in an enterprise system.

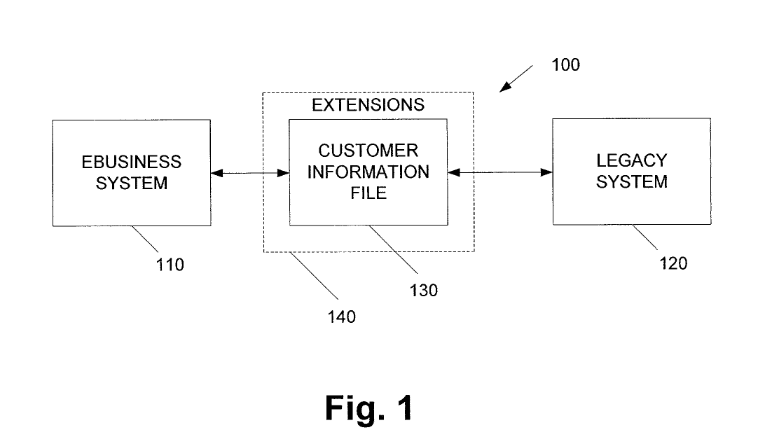

A schematic diagram of an embodiment of an enterprise system according to the present invention is illustrated in FIG. 1.

In one embodiment, the enterprise system 100 includes an eBusiness system 110. The eBusiness system 110 includes one or more eBusiness applications that can operate on one or more conventional servers. The enterprise system 100 includes a back-office or legacy system 120. The legacy system 120 includes one or more legacy applications that can operate on one or more conventional servers. In one embodiment, the enterprise system 100 may include several legacy systems 120.

The enterprise system 100 includes a Customer Information File (CIF) 130. A CIF 130 is a platform that, in one embodiment, is configured as a central database of business information for an enterprise. In one embodiment, the CIF 130 includes a relational database with several data model tables that store various categories of business information, such as information related to customers, companies, households, products, etc. Various business transactions and processes can be performed on the information in the CIF 130. Some exemplary business transactions include the addition of new records or other information to the database. Other business transactions include the modification, such as updating or deleting, existing information in the database.

The CIF 130 also includes various functions that facilitate the operation of the enterprise. Some of the functions are related to the handling and processing of information. Some exemplary functions include inserting, updating, deleting, and querying of information.

When the CIF 130 is used as the central database for an enterprise, the CIF 130 interacts through software modules to provide a common view of a customer across multiple eBusiness applications, disparate CRM systems, and legacy applications. The CIF 130 forms a foundation for business process automation and simplifies the integration of distributed customer information in an enterprise.

In one embodiment, the CIF 130 can be variable in size. For example, the CIF 130 can be extended to hold additional subsets of information by adding more tables to the database. In that scenario, the CIF 130 functions as the base module for any extensions, which are represented as extensions 140 in FIG. 1.

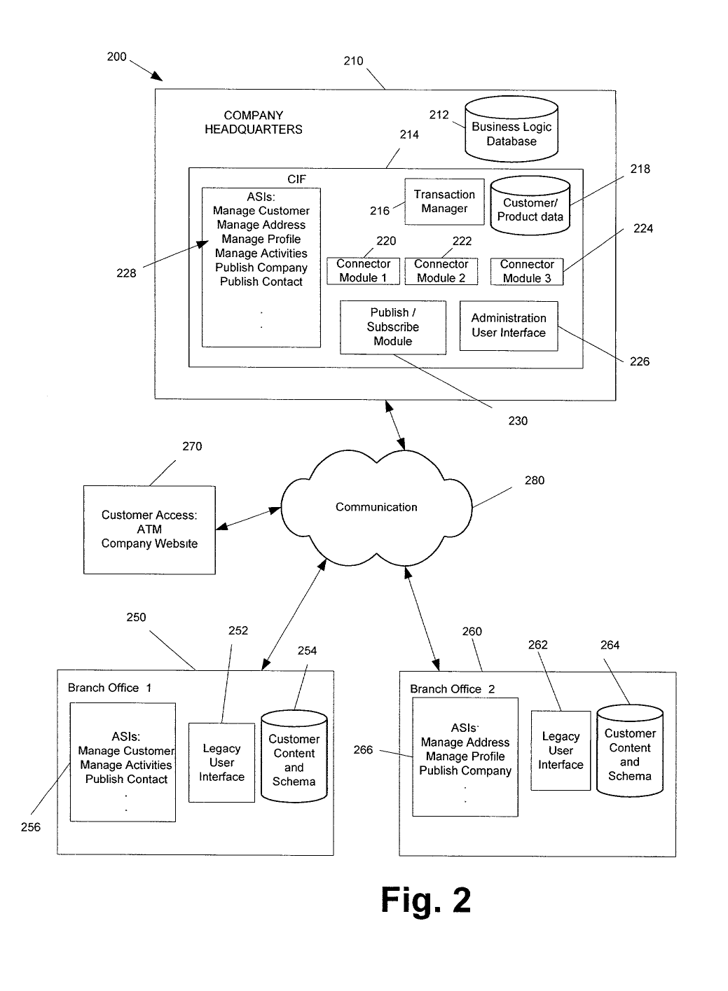

An exemplary system in which the teachings of the present invention can be implemented is illustrated in FIG. 2. As illustrated, an enterprise system 200 includes a primary system 210 and several legacy systems 250, 260, and 270. In alternative embodiments, the enterprise system 200 can include any number of legacy systems.

In one embodiment, the primary system 210 of the enterprise system 200 can be the functional headquarters of a company, such as a bank. Legacy systems 250 and 260 can be remote or branch systems of the enterprise system 200 that correspond to branch offices of the bank.

Legacy system 270 is used to generically represent an access system or application that a customer can use to communicate directly with the primary system 210. The “access system or application” can be any type of system or application. In alternative embodiments, legacy system 270 can be a website of the enterprise system 200, an automated teller machine (ATM), etc.

In enterprise system 200, legacy systems 250, 260, and 270 exchange messages and information with the primary system 210 via communication 280. Communication 280 may be any type of connection or mode of communication that enables communication between the systems of the enterprise system 200. For example, communication 280 can be accomplished via a local area network (LAN), a wide area network (WAN), the Internet, a dial-up connection, or any other type of communication.

In one embodiment, the primary system 210 includes a business logic database 212 that contains the relevant programs and logic for the primary system 210.

The primary system 210 includes a CIF 214. Some of the components of the CIF 214 in this embodiment include a transaction manager 216, a database 218, connector modules 220, 222, and 224, and an administration user interface 226. The function of each of these components is discussed in detail below.

In one embodiment, the CIF 214 can include a data manager, an object manager, and a limited interface that can be used for administrative tasks. The data manager and object manager can contain the functionality for the CIF 214. In alternative embodiments, the CIF 214 can be implemented with or without a standard eBusiness application.

The database 218 of the CIF 214 includes business information for the enterprise system 200. Database 218 can store various types of information including predefined data schema (e.g., table objects, index objects, etc.), repository objects (e.g., business objects and components, view definitions and visibility rules, etc.), and user's or customer's data or information.

Some of the repository objects of the database 218 include business components and business objects. Business components are configurable software representations of various business rules or concepts such as accounts, contacts, opportunities, service requests, solutions, etc. Business components can be built, for example, using a programming language, such as C++, supporting the object-oriented paradigm.

Business objects can include one or more business components. Business objects represent encapsulations of data or information from a data source. Standard business objects represent encapsulations of data stored in database 218. Each standard business component typically corresponds to a table of data in database 218. Data from database 218 is also represented in encapsulated form by standard business objects within a user interface.

A user wishing to access data related to a particular account can access a screen corresponding to the business object-Account. The screen might include different views corresponding to various business component types within a business object, such as an address view, a transaction history view, or a contact history view. Each of these business components can map to a table in database 218.

In one embodiment, the CIF database 218 can contain different categories of information. For example, the CIF database 218 can contain information related to a contact or customer, information related to a company, and information related to a household. Each of these categories of information can be inter-related.

Information in the contact or customer category of information can be related to many different contacts or persons. This information can be divided into several sub-categories or fields. A profile for each contact can be maintained by the database 218. Information related to the address and activities for each contact can be stored in the database 218. The database 218 can also store information associating a product with one or more contacts.

Information in the company and household categories of information can be related to many different companies and households. This information can be stored in formats similar to those identified above for contact-related information. Information related to the relationships between particular contacts, companies, and households can also be stored in database 218.

In one embodiment, the CIF 214 includes several information file modules that can be used to accomplish customer information management objectives of an enterprise. The modules include: (a) customer information profile modules that can be used to develop basic and extended profiles and relationships between the profiles; (b) a product information file module that maintains information including historical customer relationships with a product line, price lists, etc.; (c) a marketing information file module that maintains marketing data, such as historical marketing data; (d) a sales information file module that maintains information relating to leads and other sales data; and (e) a service information file module that includes the addition of service request, solutions, and other service data.

Business applications in an enterprise system utilize business information in numerous business transactions on a daily basis. The enterprise system needs to maintain the accuracy of the business information to enable systems in the enterprise system to operate on the information.

In one embodiment, some types of operations or business transactions that can be performed can be divided into two categories. The first category is the management of information, which includes the insertion, deletion, or the modification of information in the database 218. The second category is the looking up of information, which includes the querying and/or retrieval of information based on a specific or general request.

The CIF 214 includes a systems administration infrastructure that can be used to control the operations of the CIF 214 and relevant legacy systems in the enterprise system. Some of these operations include the infrastructure to manage connection information, privileges, and publish/subscribe characteristics for all systems accessing the CIF 214 and its information file modules. For example, the infrastructure can be used to monitor and confirm the privileges of legacy systems that access the CIF 214.

In one embodiment, the system administration infrastructure includes a CIF table-level module that can be used by an administrator to create all of the necessary tables for the operation of the CIF 214. Some exemplary tables include: a system reference table; a system privileges table; and a customer reference administration table. Some of these tables can include information relating to the systems that access the CIF 214.

The system reference table is a table that stores information about all of the systems that are registered with the primary system 210. Some exemplary information stored in the system reference table includes information such as a system name, an IP address, a description, connectivity information, etc. The information also includes indications whether the particular system wants to receive updates to the information stored by the primary system 210.

The system privileges table is a table that stores the privileges for all of the systems. When legacy systems register with the primary system 210, the administrator of the primary system can determine the privileges of the legacy systems. The privileges are rights that the legacy system has relating to the information stored in CIF database 218. The administrator can restrict the ability of some legacy systems to modify or add information to the CIF database 218. The privileges administration of the CIF 214 provides the functionality to grant query, insert, update, and delete privileges at object levels (i.e., Contact, Account, Household) to each system registered with the CIF 214.

The customer reference administration table is a table that stores the unique ID used by each system in the enterprise system 200 that accessing the CIF 214. The unique ID can be used in the determination of whether a legacy system has the privileges to request or instruct the CIF 214 to perform a particular process.

In one embodiment, the system administration infrastructure includes other modules that can be used to facilitate the control of the CIF 214 and legacy systems. One module is a CIF coding level module that generates C++ code to support the functions of: administering system privileges; creating customer IDs; and the maintaining and processing of publishing/subscribing information.

Another module is a CIF user interface (UI) module. This CIF UI module can be used to perform the configuration of the user interface that administrators can use to set up the operation of the CIF 214. Some of the views that are configured by the CIF UI module include: a contact administration view; a company reference administration view; a household reference administration view; and a system administration view.

User interfaces provide the applets, views, charts, reports, etc. associated with one or more applications. Various types of clients can be supported via user interface. These various types of clients may include traditional connected clients, remote clients, thin clients over an intranet, Java thin clients or non-Windows-based operating systems, and HTML clients over the Internet, etc.

In one embodiment, the CIF 214 includes an administration user interface module that configures the administration user interface 226 for the CIF 214. The user interface 226 includes a business service screen that includes a contact administration view, a company reference administration view, a household reference administration view, and a system administration view. Each of these views is discussed in detail below. The user interface 226 also includes a system privileges administration view that can be used to set the privileges for all of the legacy systems that are accessing the CIF 214.

The business service screen is available to administrators for the purpose managing business information and applications accessing business information. The system administration view displays information about the systems that are part of the enterprise system. The customer or contact administration view displays information about the customers for whom information is stored. The company reference administration view displays information about the companies for information is stored. The household reference administration view displays information about the households for which information is stored.

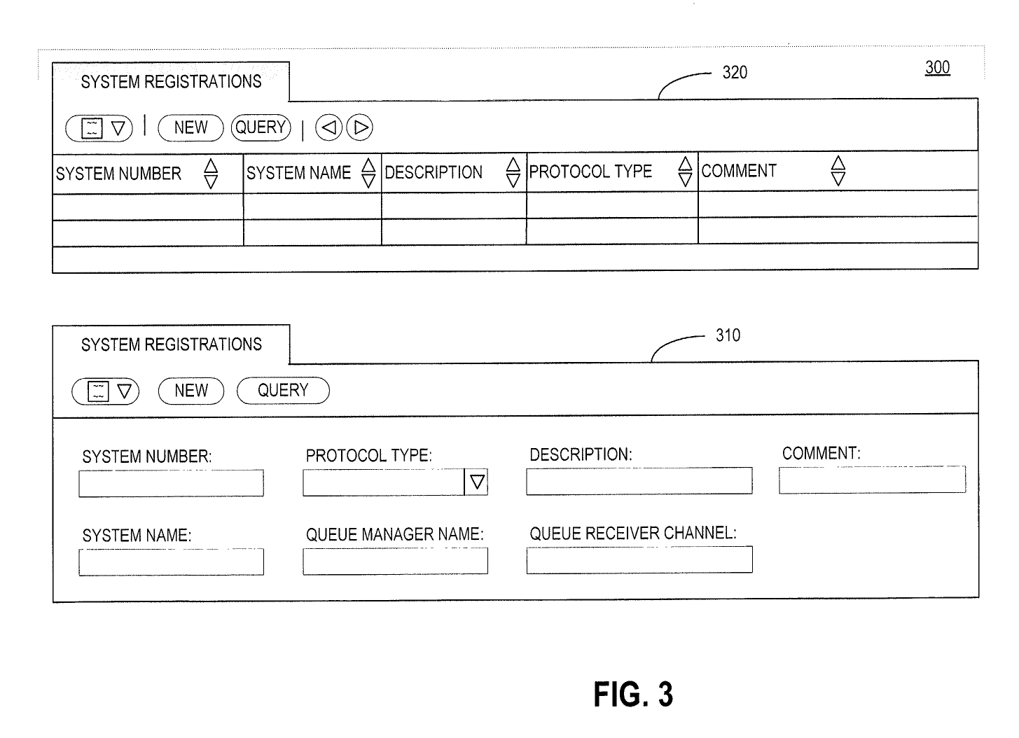

FIG. 3 depicts a system administration view 300 according to an example embodiment of the present invention. System administration view 300 is intended to help an administrator view, modify, and administer all applications within an organization that access the CIF 214. System administration view 300 displays the details about the configuration of a particular legacy system.

As illustrated in FIG. 3, in one example, the system administration view 300 can include a user interface portion 310 and a table 320. An administrator can add or modify information via the user interface portion 310. The table 320 includes specific information about each legacy system and can include any number of rows. For example, the unique System Number, System Name, and Protocol Type of each legacy system is included.

Table 1 shows the relevant parameters used in the system administration view 300 for each legacy system:

| Parameter | Description |
|---|---|
| System | Unique ID assigned to each system on the application or |
| Number | enterprise network |
| System Name | Name of the legacy system, such as Siebel Financial |
| | Services |
| Protocol Type | Protocol for the legacy system |
| Description | Brief description of the legacy system instance |
| Queue | Name or identification of the queue manager program or |
| Manager Name | module |
| Queue | Name or identification of the channel |
| Receiver | |
| Channel | |
| Comments | Any additional comments relating to this legacy system |

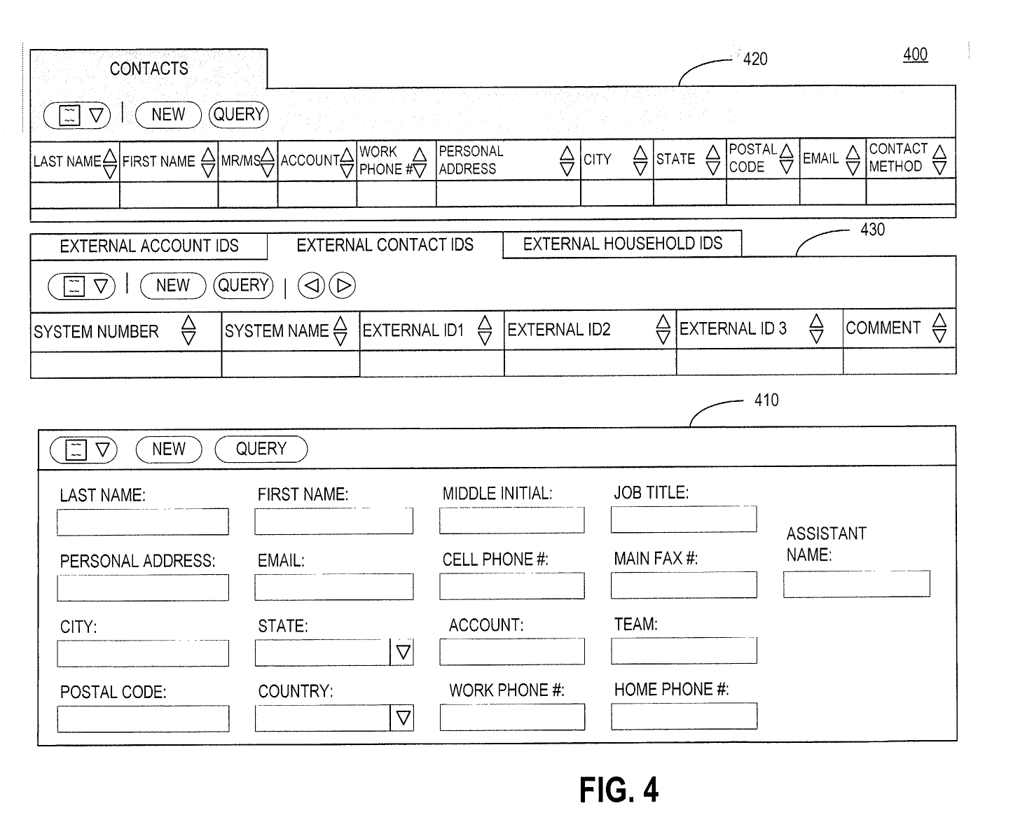

FIG. 4 depicts a contact reference administration view 400 according to an example embodiment of the present invention. Contact reference administration view 400 is intended to help an administrator view, modify, and administer all customer IDs used in the legacy systems that access the CIF 214. Contact reference administration view 400 displays the details about each of the customers for whom information is stored.

As illustrated in FIG. 4, the contact reference administration view 400 can include a user interface portion 410 and tables 420 and 430. Table 420 includes specific information about each customer and table 430 includes several fields for external Ids for the particular customer from each legacy system. While tables 420 and 430 are illustrated with a single row, multiple rows can be used.

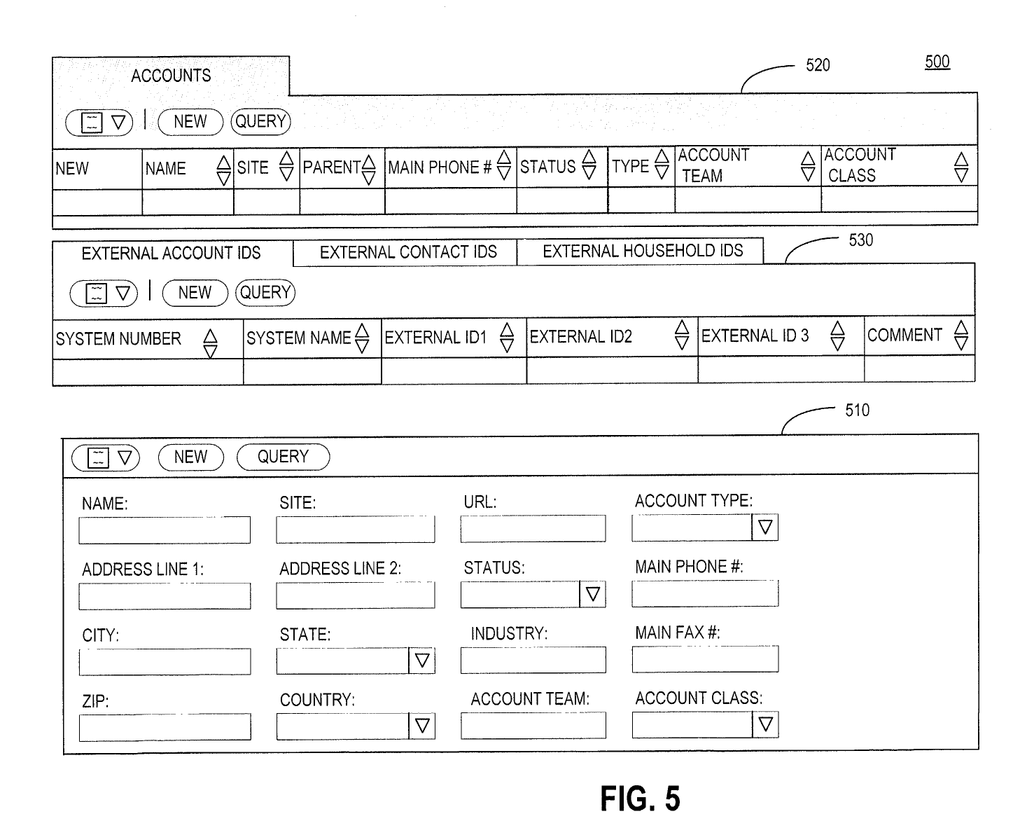

FIG. 5 depicts a company or account reference administration view 500 according to an example embodiment of the present invention. Account reference administration view 500 is intended to help an administrator view, modify, and administer all customer IDs used in the legacy systems that access the CIF 214. Account reference administration view 500 displays the details about each of the company for which information is stored.

As illustrated in FIG. 5, the account reference administration view 500 includes a user interface portion 510 and tables 520 and 530. Table 520 includes specific information about each company and table 530 includes several fields for external Ids for the particular company from each legacy system. While tables 520 and 530 are illustrated with a single row, multiple rows can be used.

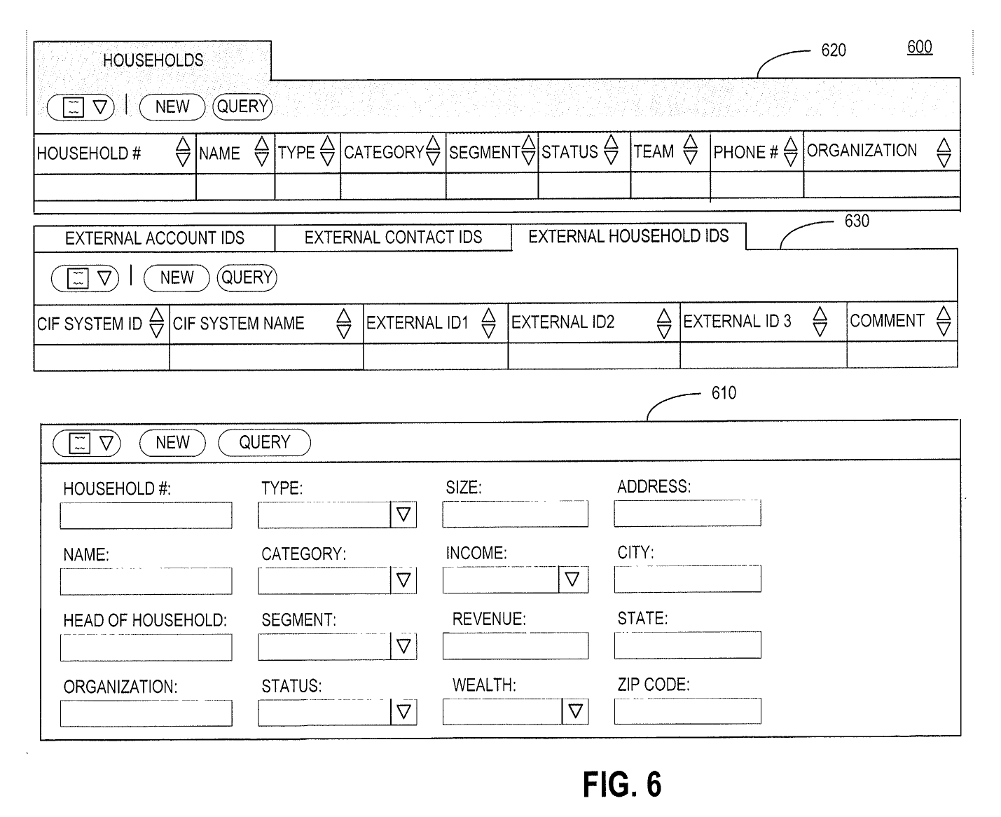

FIG. 6 depicts a household reference administration view 600 according to an example embodiment of the present invention. Household reference administration view 600 is intended to help an administrator view, modify, and administer all customer IDs and other information used in the legacy systems that access the CIF 214. Household reference administration view 600 displays the details about each of the households for which information is stored.

As illustrated in FIG. 6, the household reference administration view 600 includes a user interface portion 610 and tables 620 and 630. Table 620 includes specific information about each household and table 630 includes several fields for external Ids for the particular household from each legacy system. While tables 620 and 630 are illustrated with a single row, multiple rows can be used.

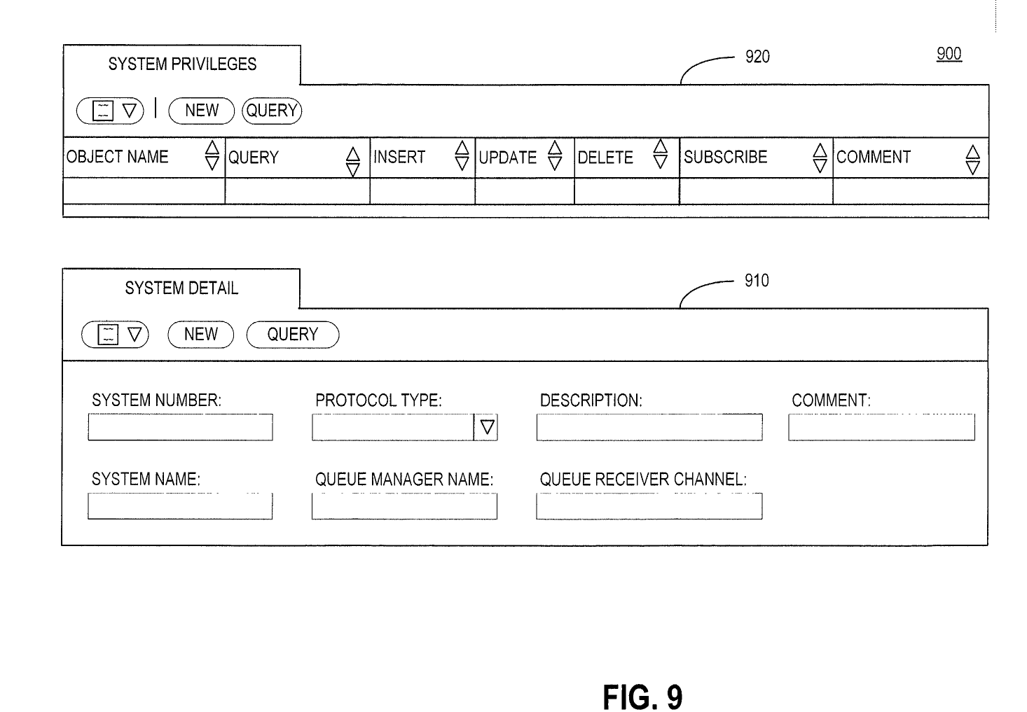

FIG. 9 depicts a system privileges administration view 900 according to an example embodiment of the present invention. System privileges administration view 900 is intended to help an administrator view, modify, and administer the privileges of the legacy systems that access the CIF 214. System privileges administration view 900 displays the details about each legacy system for which information is stored.

As illustrated in FIG. 9, the system privileges administration view 900 includes a user interface portion 910 and table 920. Table 920 includes several fields for different privileges for each legacy system. While table 920 is illustrated with a single row, multiple rows can be used.

Views 400, 500, 600, and 900 are exemplary of views that can be used at the primary system. It should be understood that the primary system implementation within the enterprise system may include variations of each of these views, each of which includes all or some of the information illustrated in views 400, 500, 600, and 900. It should also be understood that each legacy system within the enterprise system may store at least all of the information contained within an ASI if not more, but only store a subset of the information presented in a particular view.

As alluded to above, the primary and legacy systems in an enterprise system can communicate and exchange information by using messages. In one embodiment of the present invention, a legacy system can request information from a primary system with a message that includes a query or lookup command. Moreover, a legacy system can also provide new customer information or updated customer information to a primary system using messages with different commands.

The particular messages used depends on the enterprise system. The messages can be in any format that can be processed by the eBusiness and legacy systems. In one embodiment, messages exchanged by the primary and legacy systems can be in a markup language such as Extensible Markup Language (XML). XML describes a class of data objects that are referred to as XML documents, and partially describes the behavior of computer programs that process them. XML is a subset of a markup language known as Standard Generalized Markup Language. XML as referenced herein refers generally to any standard of XML, and specifically to XML 1.0, as set forth on the web site http://www.w3.org.

The system that receives a message, whether the primary system or a legacy system, processes the received message and converts it from an XML format to a format that the receiving system can use in it business processes.

Each message can invoke particular business process or transaction at the receiving system. These business processes or transactions can be pre-configured for use by any system in the enterprise system 200. When the primary and legacy systems utilize a common set of business processes, communications between the systems are facilitated and can be automated.

In one embodiment, an interface with an application which effects the invocation of a business process can generated for each business process. This interface can be an ASI, as discussed above. ASIs can be used to enable the access, management, and sharing of customer information across applications in the enterprise system 200.

ASIs are interfaces associated with the eBusiness applications for the purpose of participating in cross-application business processes. The instructions for an individual business transaction can be captured in the form of an ASI. For example, an ASI can be created for the insertion of new contact information. Similarly, another ASI can be created for the modification of a particular address for a contact. The ASIs can be used to access any type of information in the CIF 214. The ASIs are pre-configured and can be referred to as “out-of-the-box” interfaces.

The framework of an ASI is designed to support changes and upgrades to the application without having to change the ASI definition, which would cause applications that utilize the services to be re-coded. The ASI framework provides a layer of isolation between the business object model of the eBusiness system and the integration interfaces. The ASIs can be extended to expose custom fields and columns.

In one embodiment, the CIF 214 can include several ASIs 228. The CIF 214 of the primary system 210 is provided with a master set of ASIs and a table for database 218. The set of ASIs includes ASIs for the receiving and sending of data or information. The CIF 214 can also include an ASI module that generates input/output (IO) interfaces for the ASIs.

The business transactions for the primary and legacy systems can be grouped into several categories of ASIs. An ASI can be either an inbound ASI or an outbound ASI, depending on the system that invokes the ASI. In one embodiment, the CIF 214 is supported by inbound ASIs and outbound ASIs. Because the CIF 214 includes database 218, most of the ASIs used by the CIF 214 are inbound ASIs that are invoked by messages from other systems to access the information in the database 218.

Inbound ASIs are utilized by a system that receives a request for a business service or an update of information from another system. Several inbound ASIs relate to the querying, inserting, updating, and deleting of particular information in database 218.

For example, some inbound ASIs relate to the looking up of information in the database 218. In one embodiment, a Lookup Relationship ASI can be used to query relationships between contacts, companies, and households. A Lookup Customer by Product ASI can be used to query contact accounts and households based on a product identification number. A Lookup Batch Address ASI can be used to query contacts, accounts, and households based on address criteria, requested in batch mode.

Outbound ASIs are utilized to process and send requested information back to the requesting system. Outbound ASIs can also be utilized when a message with an initial request is sent by a system.

Several outbound ASIs relate to the publishing of information from one system to other systems. In one embodiment, a Publish Contact ASI can be used to publish contact information. Similarly, a Publish Company ASI and a Publish Household ASI can be used to publish company information and household information, respectively. On the contrary, a Synchronize Contact ASI, a Synchronize Account ASI, and a Synchronize Household ASI can be used to publish Contact, Account or Household information during batch time publication.

Each ASI performs a particular function. Thus, ASIs can be categorized according to the function that they perform.

One category of ASIs is a manage customer category. In this category, the inbound ASIs process (insert, delete, and/or modify) contact, company, and household information and the outbound ASIs facilitate the lookup and retrieval of information from the database 218. In one embodiment, the CIF 214 includes an ASI that looks up contact information based on a name. A legacy system that sends this ASI includes a name in the request in order to obtain contact information associated with the name. In another embodiment, the CIF 214 can include ASIs that look up company information or household information by name.

Another exemplary category of ASIs is a manage address category, which includes inbound ASIs that process address information for contacts and companies and outbound ASIs that facilitate the lookup and retrieval of address information from the CIF 214 for contacts and companies.

Another exemplary category of ASIs is a manage profile category, which includes inbound ASIs that process profile information for contacts and companies and outbound ASIs that facilitate the lookup and retrieval of profile information from the CIF 214 for contacts and companies.

Another exemplary category of ASIs is a manage activities category, which includes inbound ASIs that process information relating to activities of contacts and companies and outbound ASIs that facilitate the lookup and retrieval of activity information from the CIF 214 for contacts and companies.

Another exemplary category of ASIs is a manage products category, which includes inbound ASIs that process information relating to products associated with contacts and companies and outbound ASIs that facilitate the lookup and retrieval of product information from the CIF 214 for contacts and companies.

Table 2 shows some exemplary ASIs for the CIF 214:

| Category | ASI Name | Description | Type |
|---|---|---|---|
| Manage | Manage Contact | Insert, update and delete Contact | Receive- |
| Customers | (Method) | information | Send |
| Manage | Manage Company | Insert, update and delete Company | Receive- |
| Customers | (Method) | information | Send |
| Manage | Manage Household | Insert, update and delete Household | Receive- |
| Customers | (Method) | information | Send |
| Lookup | Lookup Contact | Query Contact information | Receive- |
| Customers | | | Send |
| Lookup | Lookup Company | Query Company information | Receive- |
| Customers | | | Send |
| Lookup | Lookup Household | Query Household information | Receive- |
| Customers | | | Send |
| Lookup | Lookup Contact | Query all contact, company and | Receive- |
| Relationships | Relationships | household relationships for a | Send |
| | | particular contact | |
| Lookup | Lookup Company | Query all contact, company and | Receive- |
| Relationships | Relationships | household relationships for a | Send |
| | | particular company | |
| Lookup | Lookup Household | Query all contact, and household | Receive- |
| Relationships | Relationships | relationships for a particular | Send |
| | | household | |
| Manage | Manage Contact | Insert, update, or delete Contact | Receive- |
| Others | Activities (Method) | Activities Information | Send |
| Manage | Manage Company | Insert, update, or delete Companies | Receive- |
| Others | Activities (Method) | Activities Information | Send |
| Manage | Manage Household | Insert, update, or delete Household | Receive- |
| Others | Activities (Method) | Activities Information | Send |
| Manage | Manage Contact | Insert, update, or delete Contact | Receive- |
| Others | Address (Method) | Address Information | Send |
| Manage | Manage Company | Insert, update, or delete Company | Receive- |
| Others | Address (Method) | Address Information | Send |
| Manage | Manage Household | Insert, update, or delete Household | Receive- |
| Others | Address (Method) | Address Information | Send |
| Manage | Manage Contact | Insert, update, or delete Contact | Receive- |
| Others | Profile (Method) | Profile Information - Subset of | Send |
| | | Contact data only related to profile | |
| Manage | Manage Company | Insert, update, or delete Company | Receive- |
| Others | Profile (Method) | Profile Information - Subset of | Send |
| | | Company data only related to | |
| | | profile | |
| Manage | Manage Household | Insert, update, or delete Household | Receive- |
| Others | Profile (Method) | profile Information - Subset of | Send |
| | | Household data only related to | |
| | | profile | |
| Manage | Manage Contact | Insert, update, or delete Products | Receive- |
| Others | Products (Method) | associated with a Contact | Send |
| Manage | Manage Company | Insert, update, or delete Products | Receive- |
| Others | Products (Method) | associated with a Company | Send |
| Manage | Manage Household | Insert, update, or delete Products | Receive- |
| Others | Products (Method) | associated with a Household | Send |
| Lookup | Lookup Contact | Query Activities Information for a | Receive- |
| Others | Activities | given contact | Send |
| Lookup | Lookup Company | Query Activities Information for a | Receive- |
| Others | Activities | given company | Send |
| Lookup | Lookup Household | Query Activities Information for a | Receive- |
| Others | Activities | given Household | Send |
| Lookup | Lookup Contact | Query Address Information for a | Receive- |
| Others | Address | given Contact | Send |
| Lookup | Lookup Company | Query Address Information for a | Receive- |
| Others | Address | given Company | Send |
| Lookup | Lookup Household | Query Address Information for a | Receive- |
| Others | Address | given Household | Send |
| Lookup | Lookup Contact | Query subset of Contact | Receive- |
| Others | Profile | information based on certain | Send |
| | | criteria | |
| Lookup | Lookup Company | Query subset of Company | Receive- |
| Others | Profile | information based on certain | Send |
| | | criteria | |
| Lookup | Lookup Household | Query subset of Household | Receive- |
| Others | Profile | information based on certain | Send |
| | | criteria | |
| Lookup | Lookup Contact | Query products based upon Contact | Receive- |
| Others | Products | information submitted | Send |
| Lookup | Lookup Company | Query products based upon | Receive- |
| Others | Products | Company information submitted | Send |
| Lookup | Lookup Household | Query products based upon | Receive- |
| Others | Products | Household information submitted | Send |
| Lookup | Lookup Contact by | Query Contact information by | Receive- |
| Customers | Product | product # (i.e. Account/Policy #) | Send |
| Lookup | Lookup Company | Query Company information by | Receive- |
| Customers | by Product | product # (i.e. Account/Policy #) | Send |
| Lookup | Lookup Household | Query Household information by | Receive- |
| Customers | by Product | product # (i.e. Account/Policy #) | Send |
| Lookup | Lookup Batch | Lookup all address matching a | Receive- |
| Others | Address | certain query, i.e. all mailing | Send |
| | | addresses | |
| Manage | Manage Customer | Request Customer ID from CID | Receive- |
| Customer ID | ID | generator without creating | Send |
| | | customer | |

Turning to legacy system 250, in one embodiment, legacy system 250 includes a legacy user interface 252, a customer content and schema module 254, and one or more ASIs 256. The legacy user interface 252 represents a user interface module that can be used by a customer, a customer representative, or other enterprise personnel to interact with the legacy system 250 and the primary system 210. The legacy user interface 252 can be any conventional interface, such as a user interface. The user interface 252 can be tailored for use by the administrator of the legacy system 250.

The customer content and schema module 254 includes customer related information that is stored and maintained by the legacy system 250. For example, the module 254 can include a database in which business information such as information related to customers that use the legacy system 250 is stored. The module 254 also includes the architecture required to support the operation of the legacy system 250.

In one embodiment, legacy system 250 can receive all or a subset of the ASIs present at the CIF 214 on the primary system 210. In one embodiment, the administrator of the primary system 210 can determine which interfaces each legacy system 250 needs. In another embodiment, the selection of ASIs is based on which business transactions the legacy system 250 will want to perform. The set of ASIs on the legacy system 250 can vary. The administrator of the primary system can also grant rights to a table or portion thereof to the legacy system 250.

In one embodiment, legacy system 260 includes a legacy user interface 262, a customer content and schema module 264, and one or more ASIs 266. The legacy user interface 262 represents a user interface module that can be used by a customer, a customer representative, or other enterprise personnel to interact with the legacy system 260 and the primary system 210. The legacy user interface 262 can be any conventional interface, such as a user interface. The user interface 262 can be tailored for use by the administrator of the legacy system 260.

The customer content and schema module 264 includes customer related information that is stored and maintained by the legacy system 260. For example, the module 264 can include a database in which business information such as information related to customers that use the legacy system 260 is stored. The module 264 also includes the architecture required to support the operation of the legacy system 260.

While not illustrated in FIG. 2, it should be understood that legacy system 270 can include a legacy user interface and one or more ASIs.

Returning to the CIF 214, in one embodiment, the CIF 214 includes a transaction manager 216. The transaction manager 216 performs requested business process operations. The transaction manager 216 performs several functions for the CIF 214 in response to ASIs that are invoked by messages from legacy systems.

The transaction manager 216 confirms whether records in a message instance exists in the database 218. The connector module 222 retrieves a system ID from the header of the message. The system administrator of the CIF 214 can use the system ID to search for the record id in the message. The transaction manager 216 also generates a UUID for each record in the message during business process invocation, when appropriate, inserts the UUIDs into both the message instance to be sent to the legacy system as well as the database 218.

In one embodiment, the CIF 214 includes three connector modules 220, 222, and 224. Connector module 220 interprets an ASI that is invoked by a message from a legacy system. Connector module 222 verifies that the legacy system that is the source of the message. In other words, connector module 222 confirms that the legacy system that sent the message has privileges to request the business transaction identified in the message. Connector module 224 confirms that the business process requested by the ASI is supported by and can be processed by the CIF 214.

As discussed above, a customer, a customer representative, or other user can generate a message via a user interface at a legacy system in an enterprise system 200. The message is sent to the primary system 210 and invokes an ASI at the primary system 210. The message is routed to the CIF 214 and processed by the appropriate ASI. The CIF 214 generates a response that includes a status of the business process and send the response to the requesting legacy system.

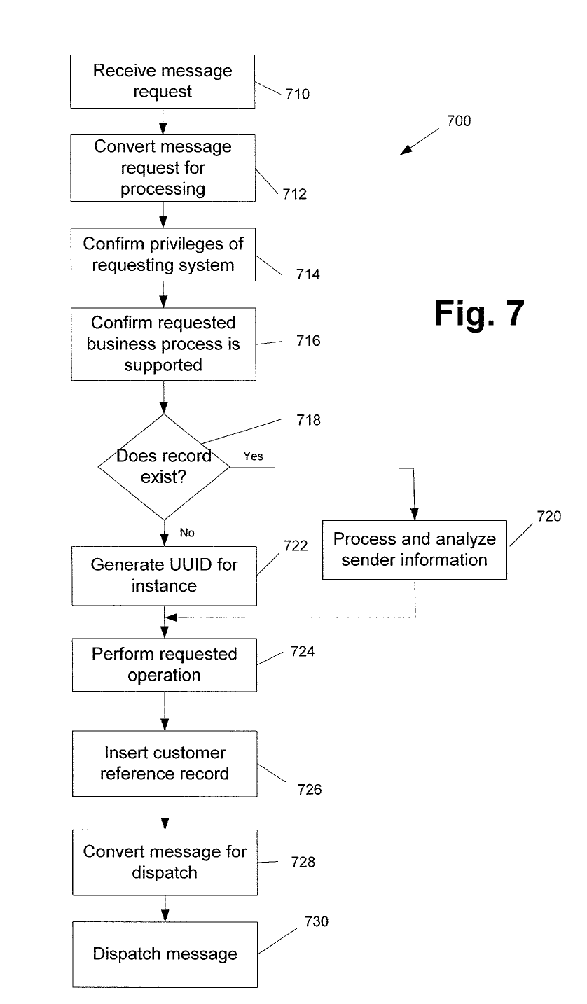

FIG. 7 illustrates an exemplary operation of a CIF according to the present invention. Flowchart 700 illustrates an exemplary process of the receipt and processing of a message by a CIF. While flowchart 700 illustrates some of the operations that are performed in this process, other combinations of operations may be carried out in variations of this process.

In this process, a legacy system has sent a message to the primary system 210 that has invoked an ASI. For example, when an administrator of legacy system 250 wants information from the CIF 214, the administrator sends a message to the primary system 210 that invokes or calls the appropriate ASI on the primary system 210. The ASI at the legacy system generates a message with a request that is subsequently sent to the primary system 210. The particular ASI invoked depends on the particular business transactions specified in the message. The message is subsequently routed at the primary system 210 to the CIF 214. One example is when a branch office of the enterprise wants to obtain some customer information from the CIF database 218.

At operation 710, the primary system 210 receives a message request from another system in the enterprise system 200. In one embodiment, the message can be in an XML format that embeds application service interfaces that are defined. An exemplary message can be a request to add a new customer.

At operation 712, the CIF converts the message into a format that it can process. In one embodiment, the connector module 220 of the CIF 214 converts the received message. For example, the message can be converted from an XML format into a primary system standard format.

At operation 714, the CIF 214 confirms the privileges of the calling system that sent the message request. In one embodiment, the connector module 222 identifies the system ID in the received message.

Connector module 222 reviews the system privileges table of the primary system 210 for the information stored for that system. The system privileges table includes information relating to the particular privileges of each registered system. If the legacy system that sent the invocation message has the privilege to request the particular business transaction, then the process continues to operation 716. Otherwise, the process stops and the CIF 214 returns an error message to the requesting system.

At operation 716, the connector module 224 confirms that the requested business process by the ASI is supported by and can be processed by the CIF 214.

At operation 718, the transaction manager 216 determines whether the record that is the subject of the received message exists in the CIF database 218. If the record exists, the process continues to operation 724.

At operation 724, the transaction manager 216 performs the requested database operation. In one embodiment, the transaction manager 216 retrieves the legacy system record specifics for processing and caching. The process continues to operation 726.

Returning to operation 718, if the record does not exist in the database, then the process continues to operation 722.

At operation 722, the transaction manager 216 generates a universal unique identifier (UUID) for the ASI input instance.

At operation 724, the transaction manager 216 performs the required executions specified in the received message into the CIF database 218.

At operation 726, the transaction manager 216 inserts the customer reference record into a message to be sent to the requesting legacy system. The transaction manager 216 also updates this change to the CIF database 218.

At operation 728, a message to be sent to the requesting system is generated. The CIF 214 converts the message into a format that the receiving system can process.

In one embodiment, the CIF 214 converts the message generated by the CIF 214 into an XML format.

At operation 730, the CIF 214 dispatches the message to the requesting system in the enterprise system 200. In one embodiment, after execution of the ASI, the CIF 214 sends status of the execution and additional information, if applicable, to the legacy system. If the execution was successful, then the CIF 214 sends a status=“success” message and any additional information that was requested. If the execution was unsuccessful, the CIF 214 sends a status=“failure” message and a failure comment.

The additional information or the particular failure comment sent to the legacy system depends on the operation mode of the ASI. If the ASI was an insert operation and successful, the CIF 214 sends the universal identifier (ID) to the legacy system. If the insert operation was unsuccessful, the CIF 214 sends one of the following exemplary failure messages: universal ID already exists, the system is down, lack of privilege for the operation, CIF required fields are incomplete, etc.

If the ASI was an update, delete or lookup operation and unsuccessful, the CIF 214 sends one of the following exemplary failure message: ID does not exist, the system is down, lack of privilege for operation, etc. A successful lookup operation results in the CIF 214 sending data to the calling system. A successful update or delete operation results in the CIF 214 only sending a successful status message.

It can be appreciated that the CIF 214 can perform a number of business processes. Several exemplary business processes of the CIF 214 are described in detail in the following examples.

### EXAMPLE 1

One exemplary process of the CIF 214 is an indirect customer lookup process. In an indirect customer lookup process, the CIF function of querying for customer information through an intermediate entity, such as a call center or a branch, is used. This process reflects the use of a Lookup Customer ASI and a Lookup Customer Detail ASI.

In this process, a customer contacts an organization through an intermediate entity, such as a legacy system. For example, a customer can contact a database at the main office of a bank via a branch office of the bank. A customer representative at the legacy system sends a message with a query for the customer to the primary system 210. For example, the query can include a first name and last name for the customer. The message is routed to the CIF 214.

The CIF 214 responds by sending a message to the legacy system with a list of matches for the query from the primary system database 218. The message includes some additional information to facilitate the identification of the customer. The customer representative identifies the customer and requests additional information from the CIF 214. Once the customer is identified, the CIF 214 responds with a message that includes the additional information requested by the customer representative.

### EXAMPLE 2

Another exemplary process of the CIF 214 is a direct customer lookup process. In a direct customer lookup process, a customer directly queries the CIF 214 for information. This process reflects the use of a Lookup Customer Detail ASI.

In this process, a customer directly contacts an organization, such as the primary system of the organization. For example, a customer can contact the primary system 200 using the Internet, an ATM, a WAP phone, etc. The customer provides basic identifying information, such as a customer ID, an account number, etc. This information enables the CIF 214 to identify the customer. The responding application of the CIF 214 queries for the customer in the CIF database 218. The CIF 214 responds to the customer with the requested customer information.

### EXAMPLE 3

Another exemplary process of the CIF 214 is a customer creation process. In a customer creation process, the CIF 214 creates a customer in the CIF database 218 in response to a message from a legacy system. This process reflects the use of a Lookup Customer ASI and a Manager Customer ASI.

In this process, a customer contacts an organization through an intermediate entity, such as a legacy system. A customer representative at the legacy system sends a message with a query (such as first name and last name for the customer) to the primary system 210. The message is routed to the CIF 214. The CIF 214 reviews the CIF database 218 and does not locate the customer. The CIF 214 responds with a message indicating that there is no match for the customer in the CIF 214.

The customer representative creates a new customer at the legacy system. Once the process is completed, the customer information is sent to the CIF 214. The CIF 214 creates the customer in the CIF database 218. The CIF 214 sends a message with the newly created customer ID to the legacy system. Upon receiving the customer ID, the legacy system can maintain information relating to the new customer.

### EXAMPLE 4

Another exemplary process of the CIF 214 is a customer update process. In a customer update process, the CIF 214 updates customer information in the CIF database 218. In this example, the CIF 214 changes the address for a customer in the database 218. This process reflects the use of a Lookup Customer ASI, a Lookup Customer Detail ASI, and a Manager Customer ASI.

In this process, a customer contacts an organization through an intermediate entity, such as a legacy system. A customer representative at the legacy system sends a message with a query (first name and last name for the customer) to the primary system 210. The message is routed to the CIF 214.

The CIF 214 responds by sending a message to the legacy system with a list of matches for the query from the primary system database 218. The message includes some additional information to facilitate the identification of the customer. The customer representative changes address and sends an address update to the CIF 214. Once the customer is identified, the CIF 214 responds with a message that acknowledges the update of the customer record.

### EXAMPLE 5

Another exemplary process of the CIF 214 is a customer bulk transaction process. In a customer bulk transaction process, the CIF 214 performs a bulk transaction, such as the printing of monthly statements. This process reflects the use of a Customer Lookup ASI.

In this process, an application administrator starts monthly statement processing. The CIF 214 receives a bulk ASI that contains a request for all records matching a particular set of criteria. In one example, the set of criteria can include the following information: Customer=“active;” Product=“Credit Card;” Statement Date “15;” and Address Type=“Billing.” The CIF 214 identifies all of the records in the CIF database 218 that match the criteria and returns all of the matching records.

### EXAMPLE 6

Another exemplary process of the CIF 214 is a customer ID creation process. In a customer ID creation process, the CIF 214 creates a new customer with previous request for a UID. This process reflects the use of a Lookup Customer ASI, a Manage Customer ID ASI, and a Manage Customer ASI.

In this process, a customer contacts an organization through an intermediate entity, such as a legacy system. A customer representative at the legacy system sends a message with a query (such as first name and last name for the customer) to the primary system 210. The message is routed to the CIF 214. The CIF 214 reviews the CIF database 218 and does not locate the customer. The CIF 214 responds with a message indicating that there is no match for the customer in the CIF 214.

The customer representative creates a new customer at the legacy system. The CIF 214 sends a new customer ID to the customer representative, who collects customer information and sends it to the CIF 214. The CIF 214 creates the customer in the CIF database 218 and sends the customer ID to the customer representative.

As discussed above, an enterprise system includes include a primary system database that includes the business information for the enterprise. While each legacy system includes its own database of information for its own business processes, the primary system database is generally the master database for the enterprise. Thus, the primary system and the legacy systems in the enterprise system utilize a subset of similar information to perform various business processes.

New information or modifications to the business information in the primary system database occur during the course of normal business processes. When any information in the primary system database is added or modified, the legacy systems need to have access to the information to provide accurate and efficient services to customers.

In one embodiment of the present invention, customer information updates can be captured on a real-time basis using an event-based publish/subscribe infrastructure. This infrastructure automates the publication of data records that have been inserted and/or updated in the CIF 214 in a given time period, thereby significantly easing the synchronization effort in an enterprise. Any inserted, deleted, updated, or queried records can be identified and sent out in a message from the CIF 214 to the legacy systems.

In one embodiment, the CIF 214 includes a business service that publishes or distributes information from the primary system database 218 to other systems in the enterprise system 200. In particular, the CIF 214 can include several ASIs, each of which is related to the publication of different categories of business processes from the database 218. The information that is published can include new records and any modifications to existing records in the database 218.

The publication process is based on several parameters. Some of the parameters are input by administrators of the legacy systems and others are generated and maintained by the primary system 210.

Legacy systems in the enterprise system 200 can register to receive particular new or modified information. In one embodiment, the legacy systems can register or subscribe for the publication services from the primary system 210. For example, the publish/subscribe administration infrastructure is used to enable legacy systems to subscribe to the CIF 214 for publication services and to manage publication of business objects.

As part of the registration process, a legacy system is prompted to input parameters that define the scope of publication services that the legacy system desires. The administrator of a legacy system can determine the scope of publication. The subscription is set at object level (i.e., Contact, Account, Household), which allows differentiation in data and frequency published.

Table 3 shows some exemplary parameters for the publish/subscribe process:

| Parameter | Control Type | Default Value | Required | Comments |
|---|---|---|---|---|
| Business | Character | Not Null, picklist | Yes | The business object for |
| Object | | | | which publication is |
| | | | | requested |
| Publish | Character | LOV | Yes | LOV contains 2 value: |
| Frequency | | | | “Real-time” or “Daily |
| | | | | Batch” |
| Publish Time | Date/Time | Calendar | Sometimes | Required for “Daily |
| | | applet with | | Batch” frequency |
| | | date & time | | |
| Last | Date/Time | Calendar | N/A | Updated by |
| Published | | applet with | | publish/subscribe |
| | | date & time | | framework |
| Start Date | Time/Date | Calendar | Yes | Date when publishing |
| | | applet with | | starts |
| | | date & time | | |
| End Date | Time/Date | Calendar | Sometimes | Date when publishing |
| | | applet with | | ends |
| | | date & time | | |
| Comments | Characters | Misc. | N/A | Any additional pertinent |
| | | | | comments concerning |
| | | | | this system |

These parameters are maintained by the primary system 210 for use during the publication process. In one embodiment, these parameters can be stored in a database of the primary system 210.

Some of the parameters are input by a system administrator and other parameters are maintained by the primary system 210. In particular, a system administrator may be required to input each business object for which publication is required. Also, a legacy system may be required to select the frequency of publication and the particular time of publication, which is applicable for the daily batch publication frequency as described below.

The first parameter that can be input by the system administrator is the particular business object for which publication of information is desired. In one embodiment, the database of a primary system may have numerous business objects. A legacy system can elect to receive information for all or a subset of the business objects in a database. As discussed above, the number of business objects for which publication is requested is related to the information used by the primary system 210.

Another parameter that can be input by the system administrator is the frequency of publication desired, the “Publish Frequency” parameter. The system administrator determines the frequency at which it wants to receive publications. In one embodiment, a system administrator can elect either a “real time” or “daily batch” frequency for the publications. In a real time publication scenario, all update information is published by the CIF 214 to registered systems in real time once the changes are identified. In a daily batch publication scenario, the CIF 214 queues the new or updated information and periodically publishes the information to registered systems depending on the “Publish Time” parameter. For example, information can be published each day at a particular time.

Another parameter that can be input by the system administrator is the time of publication. The time of publication is relevant only to the “daily batch” publication frequency. In one embodiment, the legacy system can select the particular time each day it wants to receive publication information for a particular business object. Usually, the time desired for receiving publish messages is after office hours to leverage from lighter network traffic.

Another parameter (not shown) that can be input by the legacy system is the particular transport protocol for the legacy system. This protocol is used by the CIF 214 in the generation of messages to be sent to the legacy system.

These input parameters are required for each business object for which publication is requested. In one embodiment, a legacy system can request the same frequency of publication for all of the business components for which publication is requested. Alternatively, a legacy system can request different frequencies of publication for particular business components. For example, a legacy system can request real time publication of some business objects and daily batch publication of other business objects at different times of the day.

The administrative module of the primary system maintains the other parameters identified above. For example, for each business object, the CIF 214 maintains information relating to the last time that information was published and checks for an invalid start or end time. Each of these fields includes a date component and a time component. The maintenance and updating of these fields is discussed in greater detail below with respect to the operation of the system.

In one embodiment, the administration user interface of the CIF 214 can include a business service screen that includes a publication/subscription view. The business service screen is available to administrators for the purposes of creating and managing business services. The publication/subscription view displays information about the particular parameters for each legacy system.

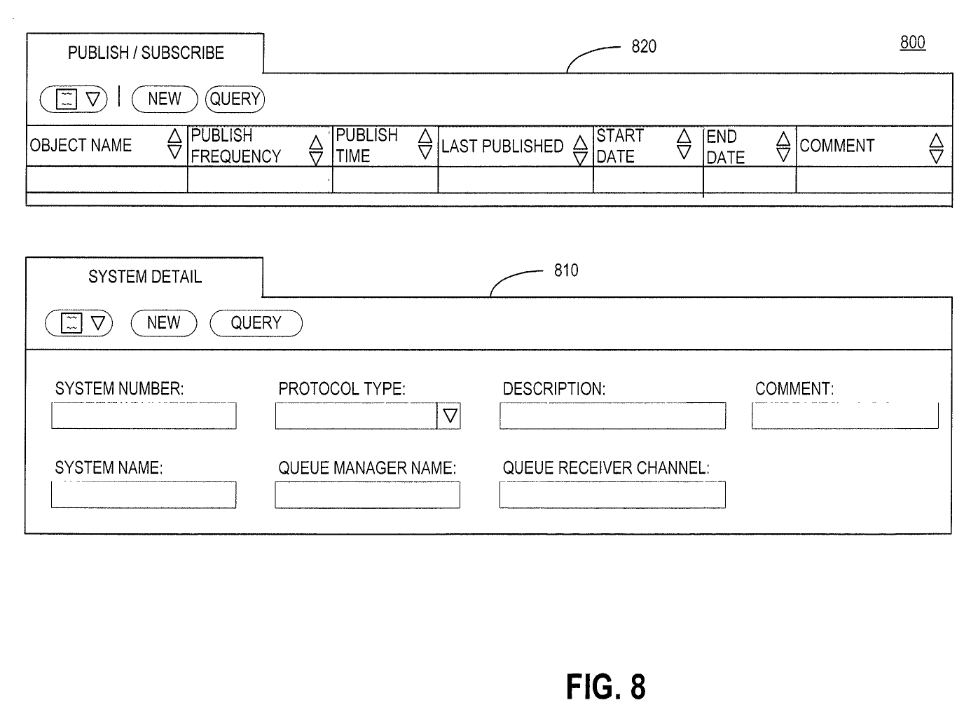

FIG. 8 illustrates a publication/subscription view 800 according to an example embodiment of the present invention. Publication/subscription view 800 enables administrators to review the relevant parameters relating to the publication process for a legacy system. The parameters can be edited by an administrator by using the appropriate buttons.

The information that is published by an ASI of the CIF 214 includes any new or modified business objects for any business components it owns. In one embodiment, the published business objects are customer-related objects such as customer, company, and household information.

Once a legacy system has registered for the publication service, the CIF 214 has the relevant parameters and configuration information for the legacy system. As new or modified information is added to the database 218, the information is identified and prepared for transmittal to the legacy systems. In one embodiment, the information is used to create a message that is sent from the CIF 214 to the legacy systems that registered for the information.

In some embodiments, some of the business objects in the database 218 may not be requested by any legacy system. Thus, the information to be published includes those business objects for which the legacy systems have specifically subscribed.

Initially, the CIF 214 reviews the configuration information for the registered legacy systems. The CIF 214 determines the set of business components for which publication has been requested by any legacy system. This set represents those business components from which information needs to be collected for publication. The CIF 214 stores the identification and number of relevant business components.

A different ASI can be configured to cover each different business component. Each ASI can be configured as a workflow module. Each workflow can be pre-configured to detect any modification of a record for a business component. Exemplary modifications include an addition of a new record, a deletion of a record, a modification of an existing record, etc. When any customer information changes, the CIF 214 invokes a process or ASI to read which systems are interested in the customer information changes. Upon determining whether any legacy system is interested in the changes, the ASI identifies the changes that need to be forwarded to the legacy systems.

When a workflow is run, the result reflects the inserted, deleted, updated, and/or queried records that are stored in one of the business components of either the contact, company, or household categories in CIF database 218.

Table 4 shows some exemplary ASIs for the publish/subscribe function of the CIF 214 for sending information to other systems:

| Category | ASI Name | Description | Type |
|---|---|---|---|
| Manage | Manage Contact | Insert, update and delete | Send- |
| Customers | Publish (Method) | Contact information | Receive |
| Publish | | | |
| Manage | Manage Company | Insert, update and delete | Send- |
| Customers | Publish (Method) | Company information | Receive |
| Publish | | | |
| Manage | Manage | Insert, update and delete | Send- |
| Customers | Household | Household information | Receive |
| Publish | Publish (Method) | | |

The CIF 214 then determines the selected publication frequency for the business component. The manner in which information to be published is identified and collected can be related to the publication frequency for that particular business component.

Once the publication frequency or frequencies for a particular business component are identified, the CIF 214 invokes executes the business service instance associated with each publication frequency. Business service methods can be invoked in various ways. From another method in the same business service, a business service method is invoked by simply calling the function or procedure by name and specifying the required arguments. From outside the business service, a business service method is invoked using an appropriate call.

In an exemplary a batch publication process, one or more ASIs are configured to search particular records for the relevant business components in the primary database for any new or modified business objects to be published. Each ASI searches through each table under the appropriate business component to collect daily information to publish. The new or modified records can be extracted from the physical table or database at that time or flagged for subsequent extraction and processing. The extracted records can be temporarily queued or stored in a file or virtual “container.”

For each publication frequency, once the customer information to be published is identified, the CIF 214 invokes another ASI to publish the changes to subscribed legacy systems. In one embodiment, the information to be published is constructed into a an XML message. In this embodiment, the invoked ASI determines which legacy systems registered for the information changes.

In an exemplary real time publication process, an ASI is invoked to construct a message hierarchy that includes several body instances or child/branch messages, each of which corresponds to a different business component or record. The information that is published includes business objects that are stored for the business components.

Each output publication message from the CIF 214 to a legacy system is constructed or tailored pursuant to the legacy system's requirements.

After the message is sent out from the CIF 214 to the legacy systems, the CIF 214 updates the time of last publication for each business component for the relevant legacy systems. In one embodiment, the CIF 214 searches for all of the legacy systems registered for the publication of the business component and updates the corresponding field in the administrative database of the primary system 210. This field corresponds to the Last Published field illustrated in FIG. 8.

When a legacy system receives a publication message, the legacy system processes the message and makes the corresponding changes to the local copy of the information. At this time, the local information includes the newly received information and is current.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents. The previous description of exemplary embodiments is provided to enable any person skilled in the art to make or use the invention. While the invention has been particularly shown and described with reference to exemplary embodiments thereof, it will be understood by those skilled in the art that various changes in form and details may be made therein without departing from the spirit and scope of the invention.

1-8. (canceled)

9. A method of transmitting an update of a data record from a primary system to a legacy system, the method comprising:
receiving a request from the legacy system, the request identifying the data record for which an update is requested and including update parameters;
identifying the changes to the data record based on update parameters; and
transmitting a copy of the updated data record to the legacy system based on the update parameters.

10. The method of claim 9, the update parameters including information related to the frequency of updates for the data record.

11. The method of claim 10, the frequency of updates being a periodic frequency.

12. The method of claim 10, the frequency of updates being a real-time frequency.

13. The method of claim 9, said identifying changes to the data record including periodically reviewing the data record, and said transmitting a copy of the updated data record occurring periodically.

14. The method of claim 9, said identifying changes to the data record occurring in real time with respect to updates of the data record.

15-20. (canceled)

21. Computer executable software code for transmitting information between a first system and a second system in an enterprise system, said software code comprising:
code to provide a first set of pre-configured application interfaces at the first system, each application interface at the first system corresponding to a business process;
code to provide a second set of pre-configured application interfaces at the second system, each application interface at the second system corresponding to a business process; and
code to exchange information between the first system and the second system using one of the first set of application interfaces and one of the second set of application interfaces.

22. The software code of claim 21, further comprising:
code to request information relating to updates to data records stored on the first system.

23. The software code of claim 22, wherein said code to request information includes code to identify data records for which updates are desired and the frequency of the updates.

24. The software code of claim 21, wherein the second set of pre-configured application interfaces is a subset of the first set of pre-configured application interfaces.

25-27. (canceled)
